(19) United States
(12) Patent Application Publication
(10) Pub. No.: US 2005/0224014 A1
(43) Pub. Date: Oct. 13, 2005

(54) Base for equestrian jump standard

(76) Inventor: Robert Diaz, San Francisco, CA (US)

Correspondence Address: DLA PIPER RUDNICK GRAY CARY US LLP, 153 TOWNSEND STREET, SUITE 800, SAN FRANCISCO, CA, 94107-1907, US

(21) Appl. No.: 10/802,461

(22) Filed: Mar. 16, 2004

(51) Int. Cl. B62K 27/00

(52) U.S. Cl. 119/705

(57) ABSTRACT

A base for equestrian jump standards according to the embodiments of the present invention includes a frame that defines three non-collinear or linear sites. Wheel mounts are positioned at two of the sites and a bracket positioned at the third site is adapted to receive a vertical post. Mobility is provided by wheels that are coupled to the wheel mounts.

### FIELD OF THE INVENTION

This invention relates to equestrian jump standards, and particularly, to bases that provide mobility to the equestrian jump standards.

### BACKGROUND OF THE INVENTION

Jump standards are used in equestrian competitions and training. The jump standards are arranged in a number of traditional configurations shown, for example, in FIGS. 1A-1C. In these configurations one or more horizontal bars H span corresponding pairs of vertical posts V. Each vertical post protrudes from a base B. Connectors called “cups” couple each horizontal bar and pair of vertical posts in the jump standard. In a typical application of a jump standard, a horse (not shown) jumps over the horizontal bars between the vertical posts. Jump standards are illustrated and described in texts such as Practical Horseman's Book of Riding, Training and Showing Hunters and Jumpers, edited by M. A. Stoneridge, ISBN 0-38519691-1.

FIG. 1A shows a schematic representation of a “single” jump standard wherein a single horizontal bar spans a single pair of vertical posts. FIG. 1B shows a schematic representation of a “double” jump standard, wherein a pair of laterally offset horizontal bars at approximately equal heights span two corresponding pairs of vertical posts. In the schematic representation of an “oxer” jump standard shown in FIG. 1C, a pair of laterally offset horizontal bars at staggered heights span corresponding pairs of vertical posts.

The bases from which the vertical posts protrude have sufficient mass and physical size to provide structural support and stability for the jump standards. An example of a prior art base B (shown in FIG. 2) has an “X”-shaped configuration, wherein orthogonal members, typically made of wood, lie in a horizontal plane on the ground. A vertical post V is secured to the orthogonal members of the base and protrudes vertically from the horizontal plane within which the orthogonal members lie. Fillets between the orthogonal members and the vertical post provide additional support for the attachment of the vertical post and the base. Typically, these components of the jump standard are nailed or screwed together forming a dedicated attachment of the base and the vertical post.

The combination of the orthogonal members, fillets and vertical posts has substantial mass, which can make it difficult for a person to reconfigure the jump standard or move the jump standard for storage or assembly at different locations. The orthogonal members of the prior art bases also contact the ground, subjecting the bases to rot and decay, which can limit the life span of the bases. In addition, when the horizontal bars are removed for storing the jump standard, the components of the jump standards still occupy a large storage space, due to the dedicated attachment between the vertical posts and the bases.

In view of these shortcomings of the prior art bases, there is a need to provide structural support for a jump standard in a manner that also enables the jump standard to be mobile and compact for storage.

### SUMMARY OF THE INVENTION

A base for equestrian jump standards according to the embodiments of the present invention includes a frame that defines three non-collinear or linear sites. Wheel mounts are positioned at two of the sites and a bracket positioned at the third site is adapted to receive a vertical post. Mobility is provided by wheels that are coupled to the wheel mounts.

### BRIEF DESCRIPTION OF THE DRAWINGS

FIGS. 1A-1C show schematic representations of traditional jump standard configurations.

FIG. 2 shows a prior art base for a jump standard.

FIGS. 3A-3F show perspective views of bases for jump standards according to embodiments of the present invention. FIGS. 4A-4B show top views of alternative configurations of bases for jump standards according to alternative embodiments of the present invention.

FIG. 4C shows a side view of the bases of FIGS. 4A-4B.

FIGS. 5A-5B show alternative brackets for the bases according to the embodiments of the present invention.

FIGS. 6A-6C show alternative wheel mounts for the bases.

FIG. 7 shows a base according another alternative embodiment of the present invention.

FIG. 8 shows support tab for the bracket.

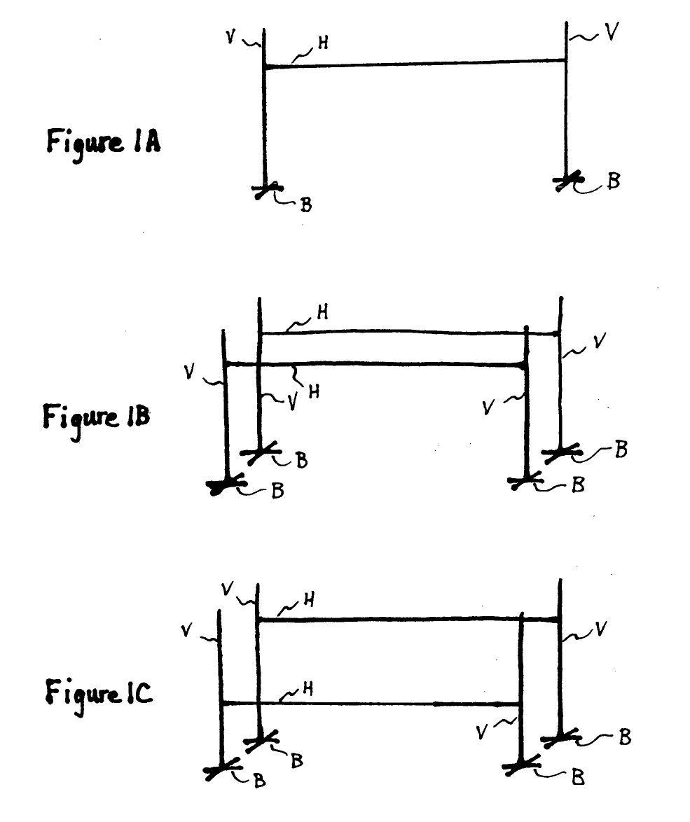

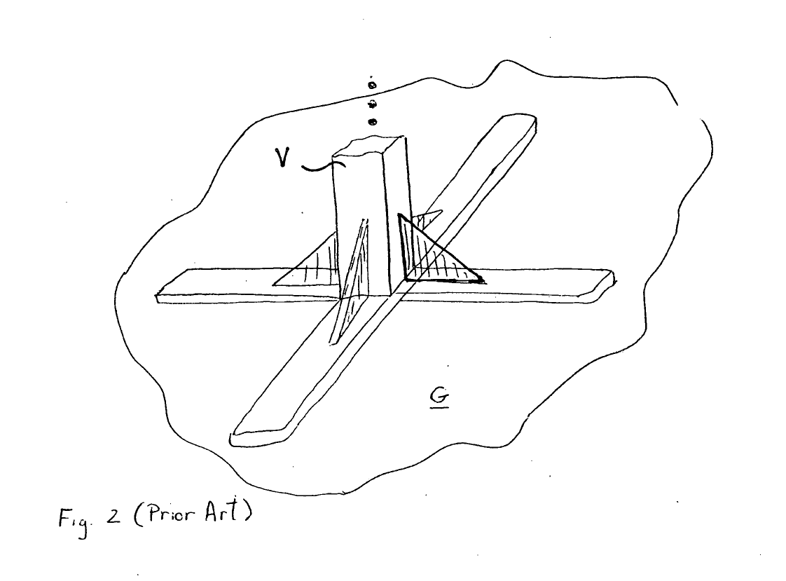

### DETAILED DESCRIPTION OF THE EMBODIMENTS

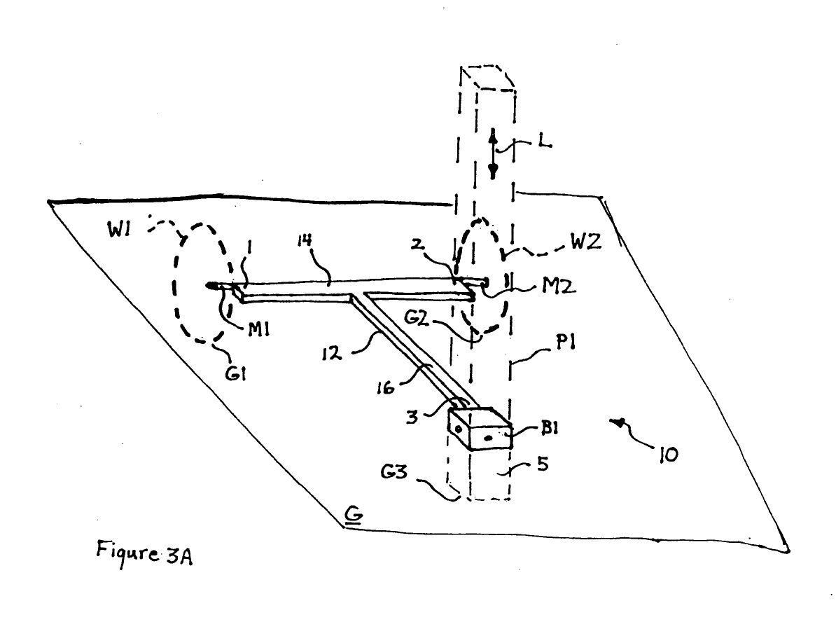

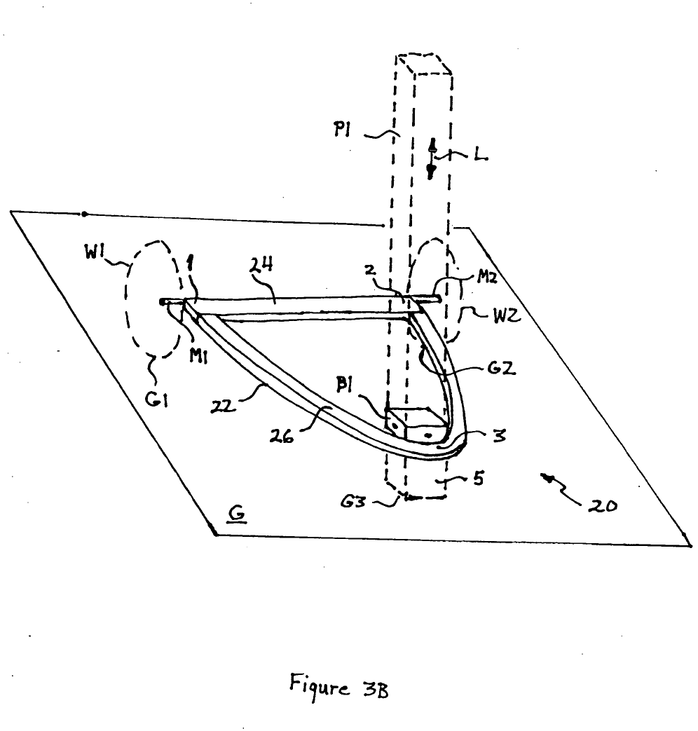

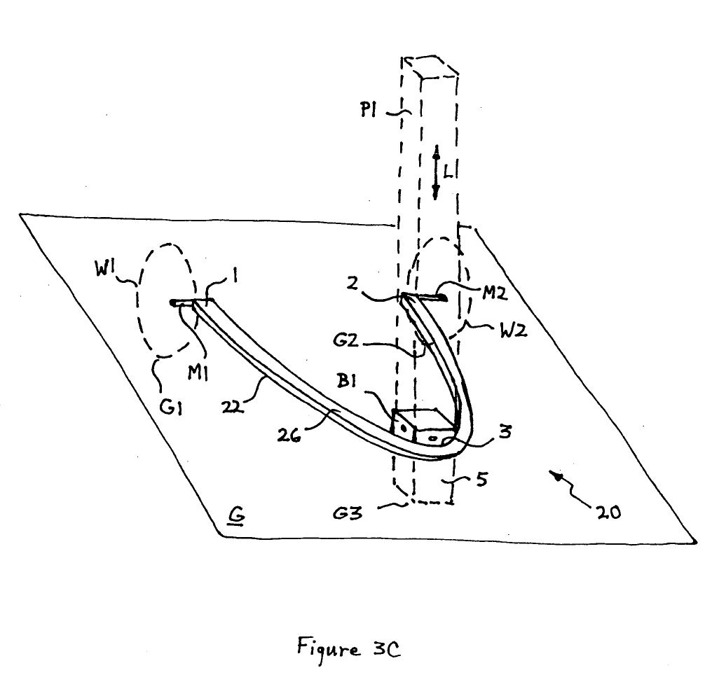

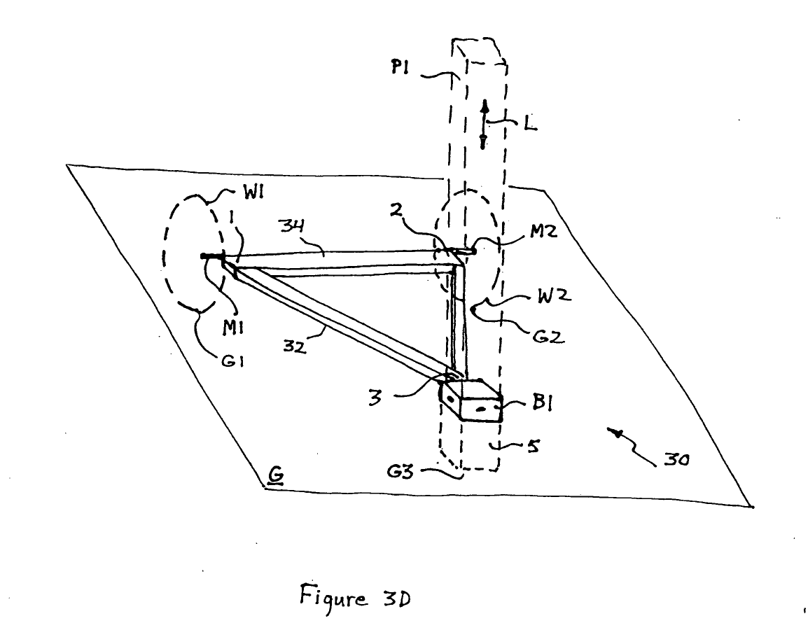

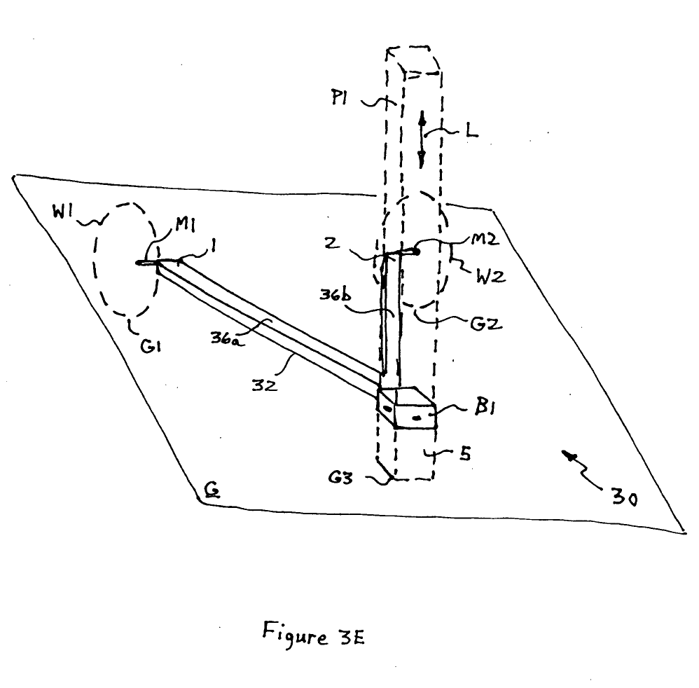

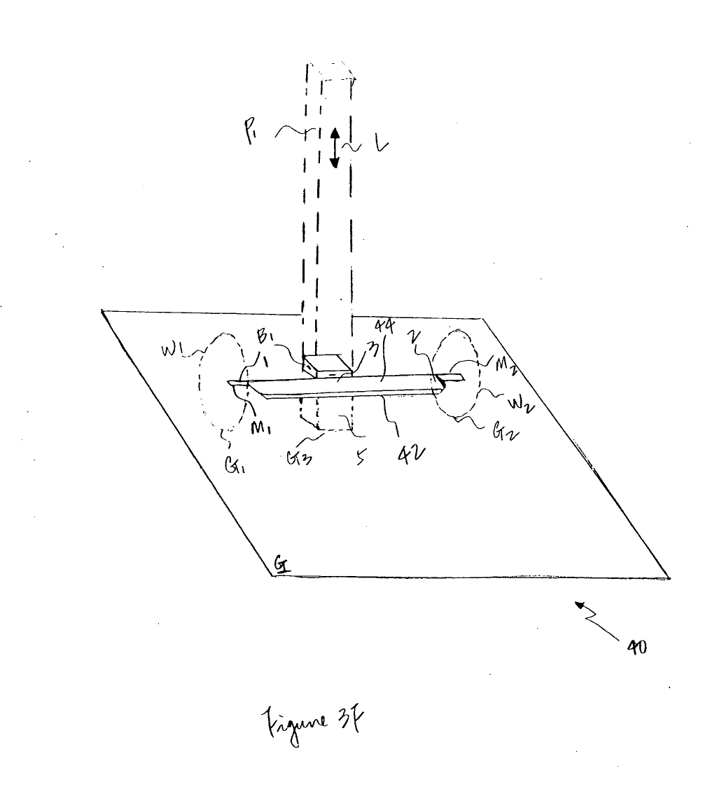

FIGS. 3A-3F show bases 10, 20, 30, 40 for jump standards according to embodiments of the present invention. The bases 10, 20, 30, 40 each includes a corresponding frame 12, 22, 32, 42 that defines three non-collinear or linear sites 1, 2, 3. Wheel mounts M1, M2 are included at the site 1 and the site 2 of the frames 12, 22, 32, 42. A bracket B1 at the site 3 of each frame is adapted to receive a post P1 having a longitudinal axis L that protrudes from a plane that is defined by the three sites 1, 2, 3. Typically, the site 3 is equidistant from the site 1 and the site 2, although alternative non-collinear or linear arrangements of the sites 1, 2, 3 are suitable.

When wheels W1, W2 are attached to the wheel mounts M1, M2, and a post P1 is received by the bracket B1, a stable support structure results from a tripod formed on the ground G by an end 5 of the post P1 at a contact position G3 on the ground G, and the wheels W1, W2 at contact positions G1, G2 on the ground G.

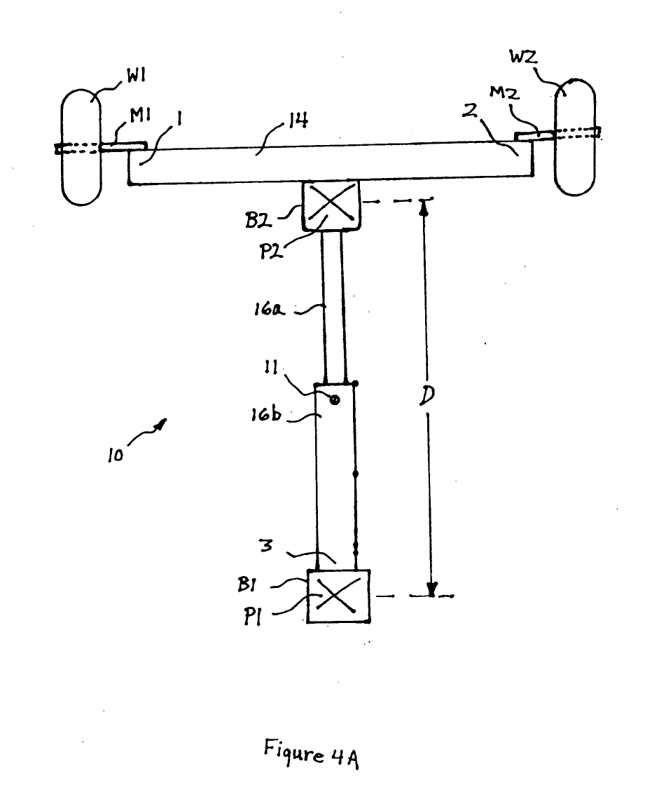

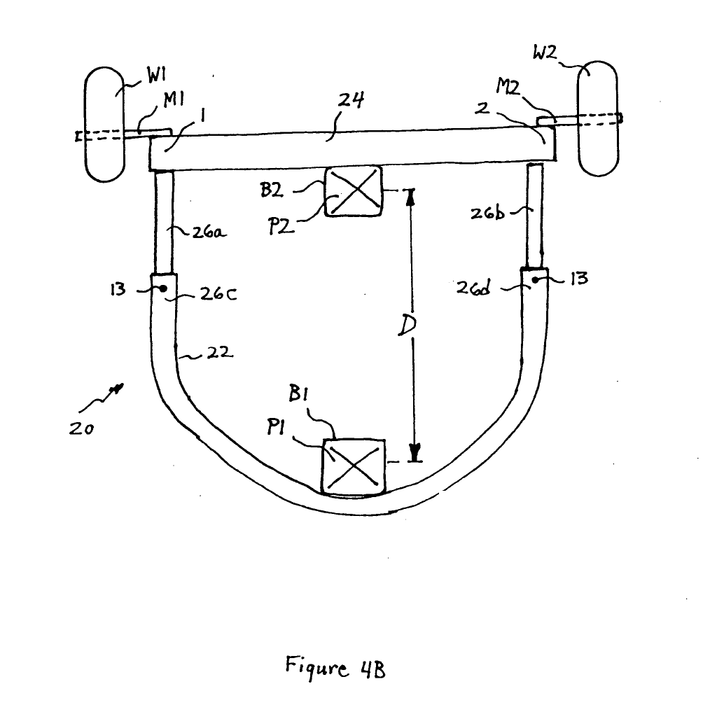

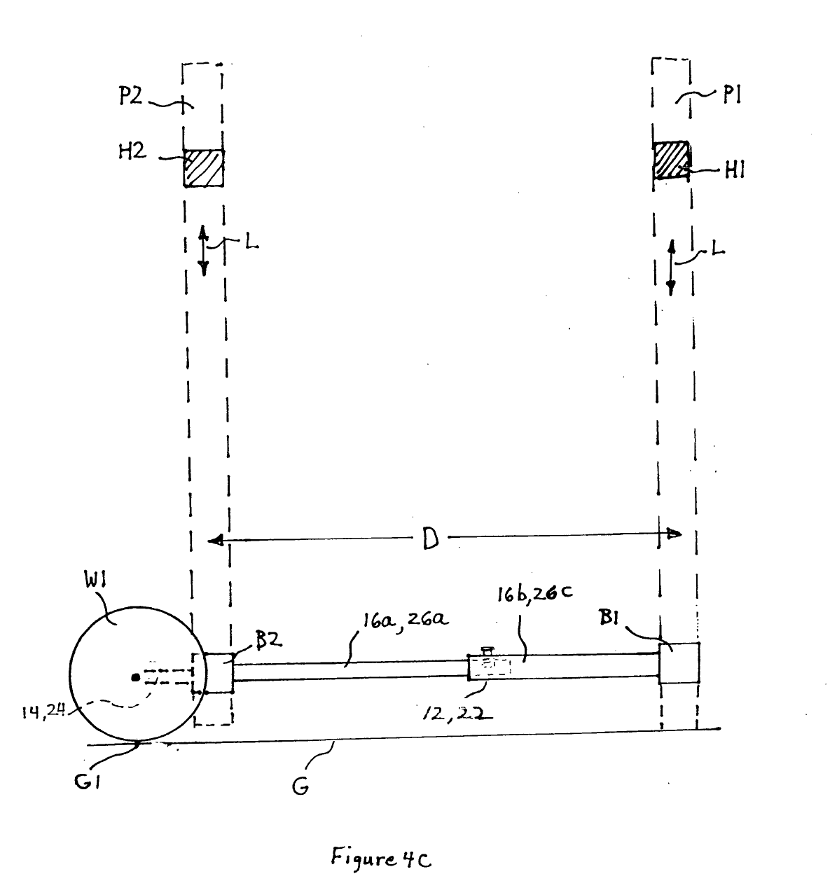

The base 10 shown in the embodiment of FIG. 3A includes a frame 12 that has a T-shape, defined by a member 14 that spans between the site 1 and the site 2, and a member 16 that intersects with the member 14 or cross over the member 14 (not shown). The bracket B1 of the base 10 is positioned at the site 3 which is at an end of the member 16 that is distal to the end of the member 16 at which the member 14 and the member 16 intersect. In an alternative embodiment shown in FIG. 4A, the base 10 includes an additional bracket B2 at the intersection of the member 14 and the member 16 or at a position anywhere along the member 16 (not shown). The bracket B2 is also adapted to receive a post P2. This embodiment provides a base 10 that is suitable for use not only in a single jump standard, but also in double jump standard or oxer jump standard when posts P1, P2 are positioned in the brackets B1, B2.

The member 16 shown in the top view of FIG. 4A is adjustable to provide corresponding adjustment in the length D that separates the bracket B1 and the bracket B2. Adjusting the length D provides for adjustment of the lateral offset between posts P1, P2, and horizontal bars H1, H2 coupled to the posts P1, P2 (shown in the side view of FIG. 4C), when the base 10 is used in the double jump standard or oxer jump standard configurations. In one example, adjustment is achieved by an inner tube 16a that penetrates an outer tube 16b. A typical adjustment range for the length D is between approximately two feet and four feet, although other adjustment ranges are accommodated by alternative designations of the lengths of the inner tube 16a and outer tube 16b.

The inner tube 16a and outer tube 16b in this example have square cross-sections, enabling adjustment of the length D while preventing rotation between the inner tube 16a and outer tube 16b. In this penetrating arrangement, any non-radially symmetric cross-section that prevents rotation between the inner tube 16a and outer tube 16b or any radially symmetric cross-section is alternatively chosen. Once adjusted, the length D is fixed via a set bolt 11 that is threaded through the outer tube 16b and tightened onto the inner tube 16a. It is appreciated that other systems or techniques are suitable for adjusting and fixing the length D. In alternative embodiments, the bracket B2 is included at the intersection of the member 14 and the member 16 or at a position anywhere along the member 16 in a base 10 wherein the member 16 has a fixed length.

The base 20 shown in the embodiment of FIG. 3B includes a frame 22 that has a U-shape, defined by a member 24 that spans between the site 1 and the site 2, and a curved member 26 that intersects with the member 24. The bracket B1 of the base 20 is positioned at the site 3 which is at a position on the curved member 26 that is distal to the member 24. In an alternative embodiment shown in FIG. 3C, the member 24 is omitted from the frame 22 and the sites 1, 2, 3 are defined by the curved member 26. In yet another embodiment shown in FIG. 4B, the base 20 includes an additional bracket B2 between the site 1 and the site 2. In the example shown, the bracket B2 is attached to the member 24 and is adapted to receive a post P2. Alternatively, the bracket B2 can be attached to a second curved member (not shown) between site 1 and site 2 at a site which is at a position on the second curved member that is distal to the member 24. This embodiment provides a base 20 that is suitable for use not only in a single jump standard, but also in double jump standard or oxer jump standard when posts P1, P2 are positioned in the brackets B1, B2. The curved member 26 shown in the top view of FIG. 4B or the second curved member (not shown) is adjustable to provide corresponding adjustment in the length D that separates the bracket B1 and the bracket B2. Adjusting the length D provides for adjustment of the lateral offset between posts P1, P2, and horizontal bars H1, H2 coupled to the posts P1, P2 (shown in the side view of FIG. 4C), when the base 20 is used in the double jump standard or oxer jump standard configurations.

In the example shown in FIG. 4B, adjustment of the length D is achieved by parallel inner tubes 26a, 26b that penetrate, by an adjustable amount, a corresponding pair of outer tubes 26c, 26d that are formed in the curved member 26. Once adjusted, the length D is fixed via a set bolts 13 that are threaded through the outer tubes 26c, 26d and tightened onto the inner tubes 26a, 26b. It is appreciated that other systems or techniques are suitable for adjusting and fixing the length D. While the embodiment shown in FIGS. 4B, 4C shows a frame 22 that provides for adjustment of the length D, the second bracket B2 can also be included in frames wherein the member 26 provides for a fixed length D.

The base 30 shown in the embodiment of FIG. 3D includes a frame 32 that has a V-shape, defined by a member 34 that spans between the site 1 and the site 2, and angled members 36a, 36b that intersect with each other at the site 3 and intersect with the member 34 at the sites 1, 2. The bracket B1 of the base 30 is positioned at the site 3 where the member 36a and the member 36b intersect. In an alternative embodiment shown in FIG. 3E, the member 34 is omitted from the frame 32 and the sites 1, 2, 3 of the frame are then defined by the members 36a, 36b. In another alternative embodiment (not shown), base 30 includes a frame that has a double V-shape defined by a first set of angled members 36a and 36b and a second set of angled members that intersect with each other at a site and intersect at the sites 1 and 2. In yet another alternative embodiment (not shown), a second bracket is positioned at the site where the second set of angled members intersect. In still another alternative embodiment (not shown), the length of at least one, two, three, or four angled members is adjustable.

The base 40 shown in the embodiment of FIG. 3F includes a frame 42 that has a linear shape defined by a member 44 that spans between the site 1 and the site 2 and includes the site 3 at a position along the member 44. The bracket B1 of the base 40 is positioned at the site 3.

The bracket B1 and B2 in the frames 10, 20, 30, 40 can be coupled to a support tab 81 as shown in FIG. 8 to provide additional stability for the base, e.g., to provide additional ground support site(s) or non-collinear site(s) if sites 1, 2, and 3 are linear sites. The support tab can either be removed from the bracket B1 or B2, e.g., support tab 82 is removed from its receiver 83 coupled to the bracket B1 or B2 or permanently attached to the bracket B1 or B2, e.g., support tab 81. Alternatively, a support tab can be coupled at site 1, 2, or 3 to provide additional stability for the base, e.g., to provide additional ground support site(s) or non-collinear site(s) if sites 1, 2, and 3 are linear sites.

The frames 12, 22, 32 shown in FIGS. 3A-3E and FIGS. 4A-4C have exemplary shapes that are suitable for the bases included in various configurations of jump standards. However, it is appreciated that alternative shapes for the frames are suitable to define the non-collinear or linear sites 1, 2, 3, to provide for integration of the bracket B1, and the bracket B2 in embodiments where the bracket B2 is included, and to accommodate the wheel mounts M1, M2. The three sites 1, 2, 3 shown provide for an efficient construction of the bases and provide stable configurations for the bases. It is also appreciated that additional sites for brackets can be established on the frames to form bases that accommodate additional posts and provide ground contacts in addition to, or as alternatives to, the ground contacts G1-G3.

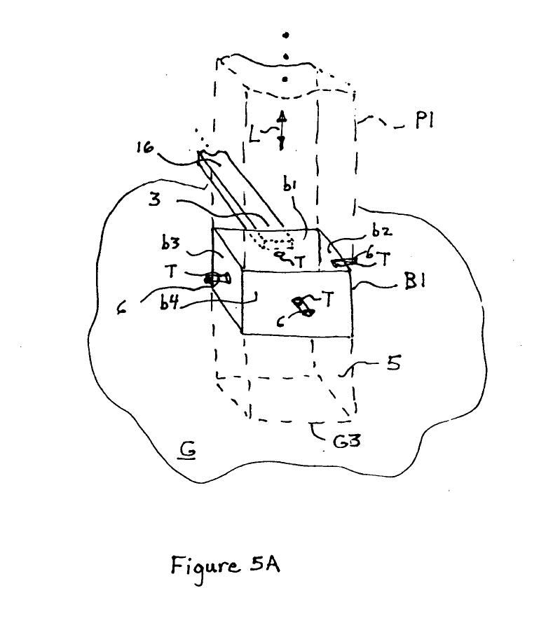

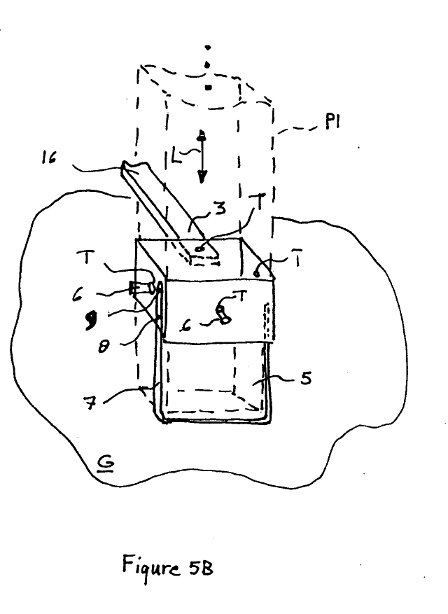

FIG. 5A shows a detailed view of one example of the bracket B1, suitable for the bases according to the embodiments of the present invention. Although reference is made to the bracket B1, the foregoing description also applies to the bracket B2. The bracket B1 has walls b1-b4 defining an internal bore that accommodates a post P1. In traditional jump standards, the post P1 is constructed from a 4″×4″ stock of lumber that is cut to an approximate length of six feet along the longitudinal axis L. For this type of post P1, the internal bore of the bracket B1 has a square cross-section that is slightly larger than the cross-sectional dimensions of the post P1. If the post P1 were to have a rectangular cross-section, circular cross-section, or cross-section of another shape, the bracket B1 would have an internal bore with a correspondingly-shaped cross-section or have an internal bore with a cross-section that would otherwise receive the post P1.

A typical use of the bases involves inserting the post P1 into the bracket B1 and moving the post P1 relative to the bracket B1 in the direction of the longitudinal axis L until the end 5 of the post P1 contacts the ground G, and the frame to which the bracket B1 is attached or integrated, fixes the angle at which the post P1 protrudes from the plane defined by the sites 1, 2, 3. Typically, the sites 1, 2, 3 lie in a horizontal plane parallel to the ground and the post P1 protrudes vertically, orthogonal to the ground. In addition, while the bracket B1 is shown oriented to establish the longitudinal axis L orthogonal to the plane defined by the sites 1, 2, 3, the bracket B1 is alternatively oriented so that the longitudinal axis L of the post P1 protrudes from the plane at other designated angles, for example, angles that provide different levels of mechanical stability to the jump standard. The bracket B1 alternatively has an open configuration (not shown), wherein one or more of the walls b1-b4 is omitted.

The bracket B1 includes a series of one or more threaded holes T in the walls b1-b4 to accommodate set bolts 6 that can be tightened into the post P1. The threaded holes T and set bolts 6 enable the post P1 to be secured in the bracket B1 or removed from the bracket B1 via a corresponding tightening or loosening of the set bolts 6. Alternatively, the walls b1-b4 of the bracket B1 has through holes (not shown) to enable the post P1 to be nailed, screwed or otherwise secured in the internal bore of the bracket B1. In another embodiment, the bracket B1 includes a series of one or more speed prongs integrated into the bracket B1 that bend when struck with a hammer or other instrument so as to penetrate the post P1 and secure the post P1 in the bracket B1. Examples of speed prongs are shown in Catalog C-2003, page 10 provided by SIMPSON STRONG-TIE CO., INC., herein incorporated by reference. The threaded holes T and set bolts 6, through holes and speed prongs can be included independently or in various combinations in the bracket B1. It is appreciated that any of a variety of other fastening systems can be used to secure the post P1 within the internal bore of the bracket B1.

FIG. 5B shows a detailed view of the bracket B1 of FIG. 5A further including an extension 7 that provides isolation between the ground G and the end 5 of the post P1. This isolation limits the exposure of the post P1 to the ground. The extension 7 is typically attached to the bracket B1 in a fixed orientation. Alternatively, the extension 7 can be pivotally attached to the bracket B1 via a pivot 8 and locked into position via a locking pin 9. Any other suitable coupling or attachment between the extension 7 and the bracket B1 is alternatively used.

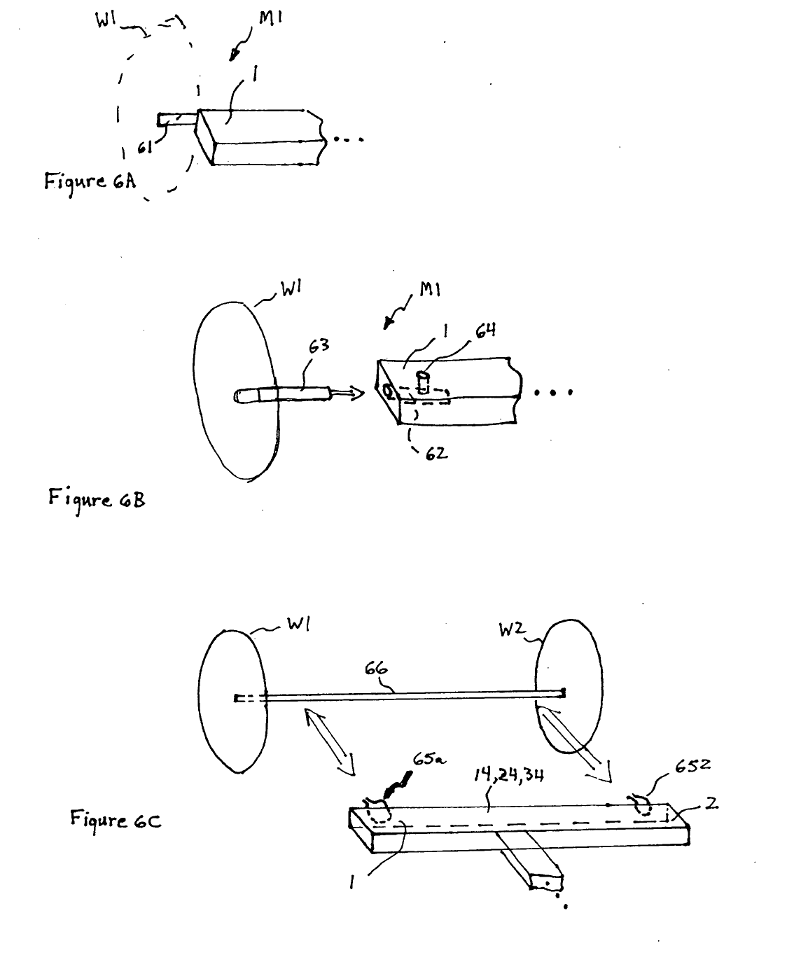

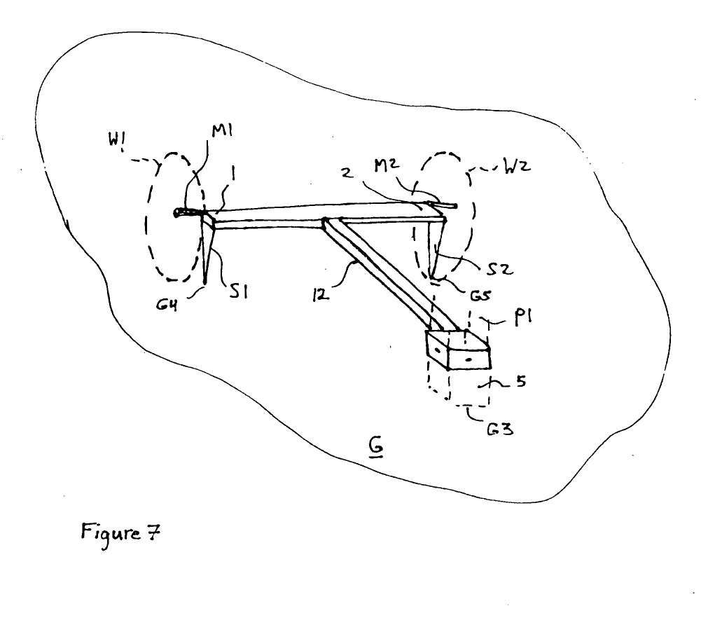

FIGS. 6A-6C show alternative wheel mounts M1, M2 suitable for the bases according to the embodiments of the present invention. When wheels W1, W2 are coupled to the wheel mounts M1, M2 of the frames 12, 22, 32, mobility is provided to the bases 10, 20, 30. In one example, the coupling of the wheels W1, W2 to the bases is a fixed, wherein the wheels remain attached to the frames of the bases while the jump standard is in use. With the wheels W1, W2 attached to the wheel mounts M1, M2 and a post P1 secured in the bracket B1, a stable support structure for the jump standard results from the tripod formed on the ground G by the end 5 of the post P1 at the contact position G3 (or by the extension 7 when included), and the wheels W1, W2 at the contact positions G1, G2, respectively, on the ground G.

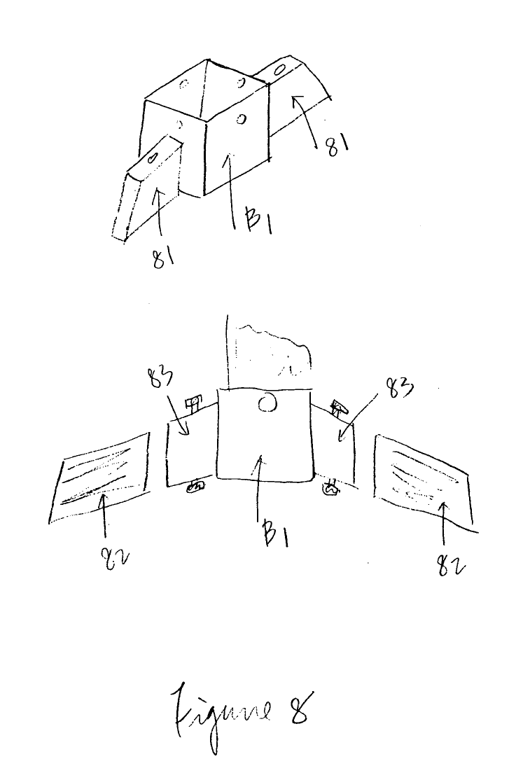

In another example, the wheels are coupled to the bases for transportation but are removed during use of the jump standard. In this example, the frame of the base includes a support tab S1 at the site 1 and a support tab S2 at the site 2, as shown in FIG. 7. Although the T-shaped frame 12 is shown, the support tabs S1, S2 can be included at the sites 1, 2 of the frames 22, 32 shown in FIGS. 3B-3E, or of frames having alternative shapes. The support tabs S1, S2 each extend downward from the frame 12 at the sites 1, 2 so that when the wheels W1, W2 shown in FIG. 7 are removed, the unattached ends of the support tabs S1, S2 engage the ground G at contact positions G4, G5. With the support tabs S1, S2 engaging the ground G and a post P1 secured in the bracket B1, a stable support structure for the jump standard results from the tripod on the ground G formed by the end 5 of the post P1 at the contact position G3 on the ground G (or by the extension 7 when included), and by the unattached ends of the support tabs S1, S2 at the contact positions G4, G5, respectively, on the ground G.

The wheel mount M1 in FIG. 6A includes an axle extension 61 that protrudes from the frame at the site 1. The axle extension 61 is of suitable length and diameter to engage a hub of the wheel W1. The wheel W1 is secured to the axle extension 61 via a cotter pin (not shown) or other suitable type of fastening scheme. In this embodiment, a similar wheel mount M2, while not shown, includes an axle extension 61 that protrudes from the frame at the site 2 to receive the wheel W2.

The wheel mount M1 in FIG. 6B includes a cylindrical bore 62 at the site 1 that receives an axle shaft 63 extending from the wheel W1 that rotates about the axle shaft 63. The cylindrical bore 62 is of suitable length and diameter to engage the axle shaft 63. The axle shaft 63 is secured in the cylindrical bore 62 via a set screw 64 in this example, although any suitable scheme for securing the axle shaft 63 in the cylindrical bore 62 is alternatively used. While not shown, a similar wheel mount M2 includes a cylindrical bore 62 that extends into the frame at the site 2 to receive the wheel W2.

The wheel mounts M1, M2 in FIG. 6C include a clip 65a at the site 1 and a clip 65b at the site 2. The clips 65a, 65b receive an axle 66 that has wheels W1, W2 secured to opposite ends. The clips 65a, 65b can be open-ended as shown, to enable removal of the axle 66 and attached wheels W1, W2 from the frame or closed to provide a more dedicated attachment of the wheels to the frame of the base.

While the embodiments of the present invention have been illustrated in detail, it should be apparent that modifications and adaptations to these embodiments may occur to one skilled in the art without departing form the scope of the present invention as set forth in the following claims.

1. A base suitable for a jump standard, comprising:
a frame operably connecting a first site, second site, and third site,
a first wheel mount at the first site;
a second wheel mount at the second site and coaxially aligned with the first wheel mount; and
a first bracket at the third site adapted to receive a post having a longitudinal axis protruding from a plane defined by the first site, second site, and third site.

2. The base of claim 1, wherein the frame includes a first member connecting the first site and the second site, and a second member connecting the third site and the first member.

3. The base of claim 2, wherein the second member connects the third site and an intersecting position on the first member.

4. The base of claim 3, wherein the intersecting position is equidistant from the first site and the second site.

5. The base of claim 1, wherein the frame includes a first member connecting the first site and the second site and wherein the third site is coupled to the first member.

6. The base of claim 5, wherein the third site is equidistant from the first site and the second site.

7. The base of claim 5, wherein the first bracket includes a support tab.

8. The base of claim 1, wherein the frame includes a curve member connecting the first site and the second site.

9. The base of claim 8, wherein the curve member connects the first site and the second site through the third site.

10. The base of claim 9, wherein the third site is equidistant from the first site and the second site.

11. The base of claim 9, wherein the frame further includes a cross member connecting the first site and the second site.

12. The base of claim 1, wherein the frame includes a first member connecting the first site and the third site and a second member connecting the second site and the third site.

13. The base of claim 12, wherein the third site is equidistant from the first site and the second site.

14. The base of claim 12, wherein the frame further includes a third member connecting the first site and the second site.

15. The base of claim 1 further comprising a second bracket at a forth site adopted to receive a post having a longitudinal axis protruding from a plane defined by the first, second, and third site, wherein the forth site is operably linked to the frame.

16. The base of claim 15, wherein the forth site is coupled to an element connecting the first site and the second site.

17. The base of claim 15, wherein the forth site is coupled to a first member connecting the third site and an intersecting position on a second member connecting the first site and the second site.

18. The base of claim 15, wherein the forth site is equidistant from the first site and the second site.

19. The base of claim 15, wherein the frame includes a first member connecting the first site and the second site and a second member connecting the third site and the forth site, wherein the first member and the second member are inter-connected via an intersecting position on the first member and the second member.

20. The base of claim 15, wherein the frame includes a first member connecting the first site and the third site, a second member connecting the second site and the third site, a third member connecting the first site and the forth site, and a forth member connecting the second site and the forth site, wherein the first member and the second member intersects at the third site and wherein the third member and the forth member intersects at the forth site.

21. The base of claim 15, wherein the frame include a first curve member connecting the first site and the second site through the third site and a second curve member connecting the first site and the second site through the forth site.

22. The base of claim 17, wherein the first member has an adjustable length.

23. The base of claim 22 wherein the first member has an outer tube and an inner tube penetratable to the outer tube, the adjustable length being determined by a depth of penetration of the inner tube into the outer tube.

24. The base of claim 19, wherein the second member has an adjustable length.

25. The base of claim 20, wherein at least two of the first member, second member, third member, and forth member have an adjustable length.

26. The base of claim 20, wherein the first member, second member, third member, and forth member have an adjustable length.

27. The base of claim 21, wherein the first curve member has an adjustable length.

28. The base of claim 21, wherein the second curve member has an adjustable length.

29. The base of claim 1 further comprising a first wheel coupled to the first wheel mount and a second wheel coupled to the second wheel mount.

30. The base of claim 29 further comprising a first support tab coupled to the frame at the first site and a second support tab coupled to the frame at the second site.

31. The base of claim 1, wherein the first bracket includes an extension, wherein the extension provides ground isolation when a post is received by the first bracket.

32. The base of claim 1, wherein the first bracket includes a support tab.

33. The base of claim 1, wherein the first bracket includes an internal bore defined by at least one wall.

34. The base of claim 15, wherein the second bracket includes an internal bore defined by at least one wall.

35. The base of claim 33, wherein the internal bore is defined by at least four walls.

36. The base of claim 33, wherein the wall includes at least one threaded hole receiving a corresponding set bolt.
